(19) United States
(12) Patent Application Publication
(10) Pub. No.: US 2022/0085636 A1
(43) Pub. Date: Mar. 17, 2022

(54) ELECTRONIC DEVICE, BATTERY PACK, AND CONTROL METHOD

(71) Applicant: CANON KABUSHIKI KAISHA, Tokyo (JP)

(72) Inventor: Takamitsu Abe, Saitama (JP)

(21) Appl. No.: 17/473,323

(22) Filed: Sep. 13, 2021

(30) Foreign Application Priority Data
Sep. 14, 2020 (JP) 2020-153787

(51) Int. Cl. H02J 7/00; H01M 10/46; H01M 10/48; H01M 10/44

(52) U.S. Cl. CPC H02J 7/007182; H02J 7/00306; H02J 7/00032; H01M 10/441; H01M 10/46; H01M 10/482; H02J 7/0047

(57) ABSTRACT

An electronic device includes a measurement unit that measures a voltage of a battery pack, and a control unit that supplies power to the battery pack in a second mode different from a first mode in which the battery pack is charged, in a case where the voltage of the battery pack is lower than or equal to a predetermined value.

### BACKGROUND

### Field of the Disclosure

Aspects of the disclosure generally relate to an electronic device, a method of controlling the electronic device, a battery pack, and a method of controlling the battery pack.

### Description of the Related Art

Japanese Patent Application Laid-Open No. 8-140281 discusses a method by which a battery pack is charged with a current lower than a standard charging current in a case where a voltage of the battery pack is lower than a predetermined reference voltage, whereas the battery pack is charged with the standard charging current in a case where the voltage of the battery pack is higher than the predetermined reference voltage.

In a case where a battery cell of the battery pack enters an over-discharged state and a voltage of the battery cell is lower than a lower-limit operation voltage of a battery management unit (BMU), the BMU enters a state where the BMU cannot be activated by power from the battery cell. In this case, an electronic device configured to charge the battery pack cannot acquire predetermined information from the BMU and thus cannot control the charging of the battery pack properly.

### SUMMARY

According to various embodiments, there is provided an electronic device that includes a measurement unit that measures a voltage of a battery pack, and a control unit that supplies power to the battery pack in a second mode different from a first mode in which the battery pack is charged, in a case where the voltage of the battery pack is lower than or equal to a predetermined value.

According to various embodiments, there is provided a battery pack that includes a battery cell, a terminal to be connected to an electronic device, a discharge switch and a charge switch that are put into an off state in a case where the battery cell enters an over-discharged state, and a control unit that is activated with power supplied from the terminal through a parasitic diode of the discharge switch, that measures a voltage of the battery cell, and that transmits battery information generated based on the measured voltage to the electronic device in a case where the battery cell is in the over-discharged state.

According to various embodiments, there is provided a method that includes measuring a voltage of a battery pack, and supplying power to the battery pack in a second mode different from a first mode in which the battery pack is charged, in a case where the voltage of the battery pack is lower than or equal to a predetermined value.

According to various embodiments, there is provided a method that includes putting a discharge switch and a charge FET into an off state in a case where a battery cell of a battery pack enters an over-discharged state, performing activation with power supplied from a terminal of the battery pack through a parasitic diode of the discharge switch of the battery pack, and measuring a voltage of the battery cell in a case where the battery cell is in the over-discharged state. Further, the method transmits battery information generated based on the measured voltage to an electronic device.

Further aspects of the disclosure will become apparent from the following description of exemplary embodiments.

### BRIEF DESCRIPTION OF THE DRAWINGS

FIG. 1 is a block diagram illustrating components of an electronic device 100 and a battery pack 200 according to a first exemplary embodiment.

FIG. 2 is a flowchart illustrating an example of an operation of the electronic device 100 according to the first exemplary embodiment.

FIG. 3 is a flowchart illustrating an example of an operation of the battery pack 200 according to the first exemplary embodiment.

### DESCRIPTION OF THE EMBODIMENTS

Exemplary embodiments, features, and aspects of the disclosure will be described below with reference to the drawings. However, aspects of the disclosure are not limited to the following embodiments.

### First Exemplary Embodiment

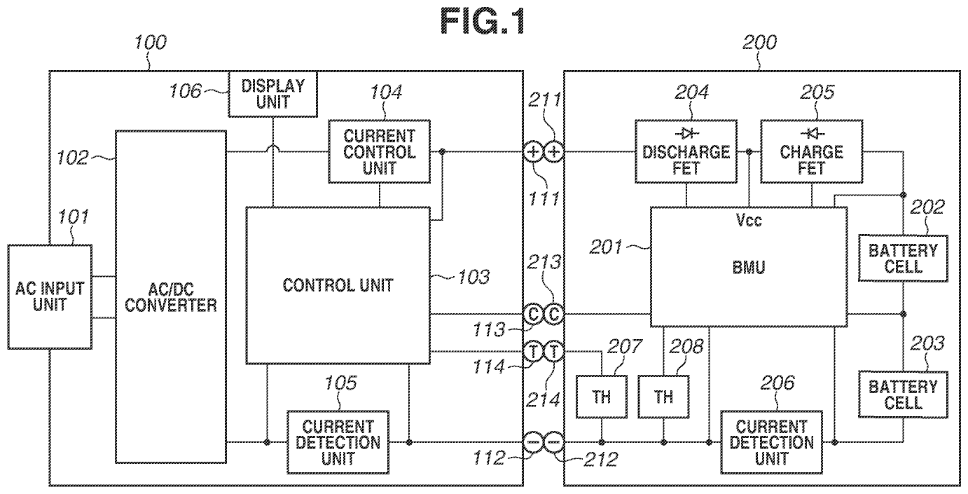

FIG. 1 is a block diagram illustrating components of an electronic device 100 and a battery pack 200 according to a first exemplary embodiment. The electronic device 100 and the battery pack 200 are connectable to each other, and the electronic device 100 is capable of charging the battery pack 200. In FIG. 1, components of the electronic device 100 that relate to a charging function are illustrated. The electronic device 100 is an electronic device operable as a charging device. The electronic device 100 may be an electronic device that includes only the charging function or may be an electronic device that includes the charging function and a function other than the charging function.

In a case where the electronic device 100 and the battery pack 200 are connected to each other, a positive terminal 111 of the electronic device 100 and a positive terminal 211 of the battery pack 200 are connected to each other, and a negative terminal 112 of the electronic device 100 and a negative terminal 212 of the battery pack 200 are connected to each other. In a case where the electronic device 100 and the battery pack 200 are connected to each other, a C-terminal 113 of the electronic device 100 and a C-terminal 213 of the battery pack 200 are connected to each other, and a T-terminal 114 of the electronic device 100 and a T-terminal 214 of the battery pack 200 are connected to each other.

The components of the electronic device 100 will be described below with reference to FIG. 1.

An alternating current (AC) input unit 101 is an alternating power input unit. An AC/direct-current (AC/DC) converter 102 converts alternating power input to the AC input unit 101 into DC power.

A control unit 103 operates as a hardware processor that controls the components of the electronic device 100 by executing a program stored in a memory. The control unit 103 controls charging of the battery pack 200. The control unit 103 measures a voltage between terminals of the battery pack 200 by measuring a voltage between the positive terminal 111 and the negative terminal 112, which are connected to the battery pack 200. The voltage between the terminals of the battery pack 200 corresponds to a battery voltage of the battery pack 200. The control unit 103 communicates with the battery pack 200 via the C-terminal 113 to acquire battery information from the battery pack 200. The battery information contains a cell voltage of each battery cell of the battery pack 200, a battery pack voltage, a charging/discharging current, a temperature, a battery level, individual information about the battery pack 200, a charging/discharging condition, a usage history, and error information. The control unit 103 controls charging of the battery pack 200 based on the acquired battery information.

A current control unit 104 is controlled by the control unit 103 and controls a voltage and a current that are supplied to the battery pack 200. A current detection unit 105 detects a current value that flows during the charging of battery cells 202 and 203 of the battery pack 200. The control unit 103 controls charging based on the current value detected by the current detection unit 105. A display unit 106 is a display member such as a light emitting diode (LED). The display unit 106 displays information indicating a charging state (charging, fully-charged state, charging error) of the battery pack 200 based on the control by the control unit 103.

The components of the battery pack 200 will be described below with reference to FIG. 1. While a battery management unit (BMU) 201 performs a protection function of protecting the battery pack 200 in the battery pack 200 according to the first exemplary embodiment, a separate protection integrated circuit (separate protection IC) can be mounted on the battery pack 200 to perform the protection function. The battery pack 200 according to the first exemplary embodiment includes two battery cells (the battery cells 202 and 203) connected in series, and the BMU 201 measures a voltage of each of the battery cells 202 and 203. A battery cell configuration of the battery pack 200 is not limited to the configuration described above and may include one battery cell, only two battery cells, or two or more battery cells connected in series. In any cases, the BMU 201 detects a cell voltage of each battery cell of the battery pack 200.

In a case where the electronic device 100 to which the battery pack 200 is connected is an image capture apparatus (camera apparatus, video camera apparatus) or a mobile terminal, the battery pack 200 supplies power to the connected electronic device 100 via the positive terminal 211 and the negative terminal 212. In a case where the battery pack 200 is connected to the electronic device 100 that includes the charging function, the battery pack 200 receives power from the connected electronic device 100 via the positive terminal 211 and the negative terminal 212.

The BMU 201 is a battery management unit that controls the components of the battery pack 200 by executing a program stored in a memory. The BMU 201 is, for example, a micro-computer. The BMU 201 includes the protection function of protecting the battery pack 200 and a control function of controlling a discharge FET (field effect transistor) 204 and a charge FET (field effect transistor) 205. The BMU 201 measures the cell voltages of the battery cells 202 and 203, detects the charging/discharging current using a current detection unit 206, detects the battery temperature using a thermistor 208, calculates the battery level, and stores battery specific information. The BMU 201 communicates with the electronic device 100 via the C-terminal 213 to transmit the acquired information to the electronic device 100.

The battery cells 202 and 203 are chargeable battery cells such as lithium ion battery cells. The discharge FET 204 is a discharge switch of the battery pack 200, and the charge FET 205 is a charge switch of the battery pack 200. The discharge FET 204 and the charge FET 205 are connected between the positive terminal 211 and the battery cell 202 in this order from the positive terminal 211 side. The BMU 201 of the battery pack 200 according to the first exemplary embodiment receives an operation power supply Vcc from a node between the discharge FET 204 and the charge FET 205.

The discharge FET 204 is controlled by the BMU 201 so that the discharge FET 204 in an on state enables discharging and the discharge FET 204 in an off state disables discharging. With an internal parasitic diode, the discharge FET 204 in the off state can cause a current to flow in a charging direction. The charge FET 205 is controlled by the BMU 201 so that the charge FET 205 in an on state enables charging and the charge FET 205 in an off state disables charging. With an internal parasitic diode, the charge FET 205 in the off state can cause a current to flow in a discharge direction.

The current detection unit 206 detects the charging/discharging current that flows in the battery cells 202 and 203. The BMU 201 acquires charging/discharging current information from the current detection unit 206. A thermistor 207 is a thermistor that detects the temperature in the battery pack 200 and is connected to the control unit 103 of the electronic device 100 via the T-terminals 214 and 114. The control unit 103 of the electronic device 100 controls charging based on the temperature in the battery pack 200 that is detected by the thermistor 207. The thermistor 208 is connected to the BMU 201. The BMU 201 detects the temperature in the battery pack 200 using the thermistor 208.

The electronic device 100 according to the first exemplary embodiment includes a normal charging mode and a BMU power supply mode as operation modes of supplying power to the battery pack 200. The normal charging mode is an operation mode in which the battery pack 200 is charged with a current lower than a standard charging current in a case where the battery voltage of the battery pack 200 is low whereas the battery pack 200 is charged with the standard charging current by a constant-current constant-voltage charging method in a case where the battery voltage is greater than or equal to a voltage that allows quick charging. The BMU power supply mode is an operation mode in which power is supply to the battery pack 200 to supply power to the BMU 201.

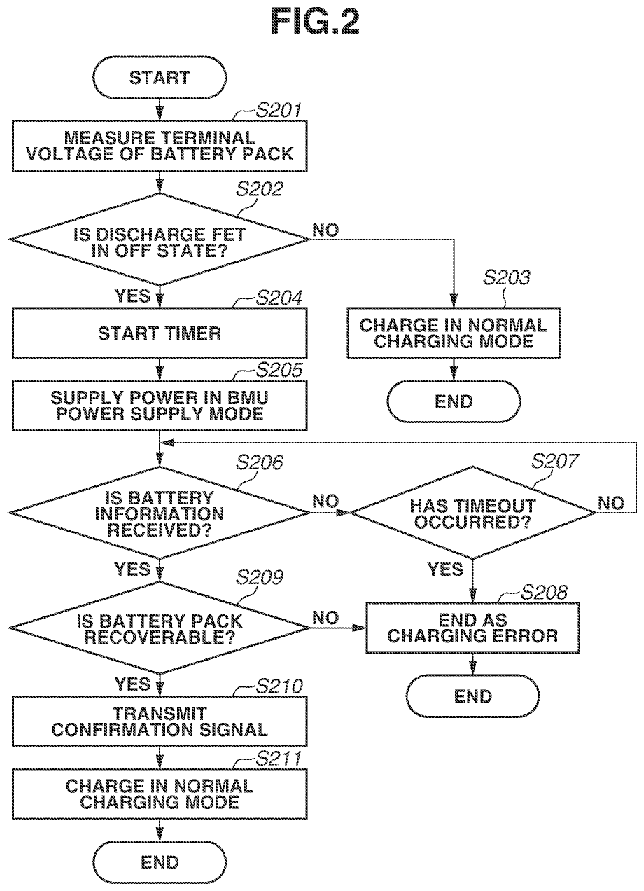

Next, an example of a process of the electronic device 100 according to the first exemplary embodiment will be described below with reference to FIG. 2. The process illustrated in FIG. 2 is controlled by the control unit 103 of the electronic device 100 by executing a program stored in a memory.

In step S201, the control unit 103 measures a terminal voltage of the battery pack 200 by measuring a voltage between the positive terminal 111 and the negative terminal 112.

In step S202, the control unit 103 determines whether the discharge FET 204 of the battery pack 200 is in the off state. In a case where the control unit 103 determines that the discharge FET 204 is not in the off state (NO in step S202), the control unit 103 determines that the battery cells 202 and 203 are not in an over-discharged state, and the control unit 103 proceeds to step S203. In a case where the control unit 103 determines that the discharge FET 204 is in the off state (YES in step S202), the control unit 103 proceeds to step S204.

Whether the discharge FET 204 is in the off state is determined based on the voltage between the positive terminal 111 and the negative terminal 112, which are respectively connected to the positive terminal 211 and the negative terminal 212 of the battery pack 200. In a case where the discharge FET 204 is in the on state, a combined voltage of the battery cell 202 and the battery cell 203 causes a potential difference between the positive terminal 211 and the negative terminal 212 of the battery pack 200, and the voltage between the positive terminal 111 and the negative terminal 112 becomes greater than or equal to a predetermined value. On the other hand, in a case where the discharge FET 204 is in the off state, a potential different is not generated between the positive terminal 211 and the negative terminal 212 of the battery pack 200. Thus, the control unit 103 determines whether the discharge FET 204 of the battery pack 200 is in the off state by determining whether the voltage between the positive terminal 111 and the negative terminal 112 is lower than or equal to the predetermined value.

In step S203, the control unit 103 supplies power to the battery pack 200 in the normal charging mode (corresponding to “first mode”) and charges the battery pack 200. The normal charging mode is an operation mode in which the battery pack 200 is charged with a current lower than the standard charging current in a case where the battery voltage is low whereas the battery pack 200 is charged with the standard charging current by the constant-current constant-voltage charging method in a case where the battery voltage is greater than or equal to the voltage that allows quick charging.

In step S204, the control unit 103 starts a timer to count a time during which the control unit 103 operates in the BMU power supply mode (corresponding to “second mode”).

In step S205, the control unit 103 supplies power to the battery pack 200 in the BMU power supply mode. The BMU power supply mode is an operation mode in which power is supplied to the battery pack 200 to supply power to the BMU 201.

For this reason, in a case where the battery cells 202 and 203 enter the over-discharged state and the discharge FET 204 is put into the off state, the charge FET 205 of the battery pack 200 is also to be put into the off state. In a case where power is supplied from the electronic device 100 to the battery cells 202 and 203 in the over-discharged state, if the charge FET 205 is in the on state, a supply voltage of the BMU 201 is the same as the total voltage of the battery cells 202 and 203. At this time, in a case where the battery cells 202 and 203 malfunction and fail to function as a battery, even if the electronic device 100 attempts to charge the battery cells 202 and 203, the voltages of the battery cells 202 and 203 do not increase, so that the BMU 201 cannot be activated.

In the normal charging mode, the battery pack 200 is charged by the constant-current constant-voltage charging method, and in a case where a decrease of the charging current to a predetermined value or lower is detected, it is determined that the battery pack 200 is in the fully-charged state. For example, in a case where the battery pack 200 is charged with the charge FET 205 being in the off state in the normal charging mode, since the power consumption of the BMU 201 is low, almost no charging current flows. Accordingly, the electronic device 100 erroneously determines that the battery pack 200 is in the fully-charged state, and terminates the supply of power to the battery pack 200. As a result of terminating the supply of power to the battery pack 200, the battery cells 202 and 203 become unrecoverable from the over-discharged state. Thus, in the BMU power supply mode, power is supplied to the battery pack 200 but whether the battery pack 200 is in the fully-charged state is not determined. In the BMU power supply mode, the electronic device 100 and the battery pack 200 perform state determination via predetermined communication while power is supplied to the battery pack 200.

In step S206, the control unit 103 determines whether the battery information is received from the battery pack 200. In a case where the control unit 103 determines that the battery information is not received from the battery pack 200 (NO in step S206), the control unit 103 proceeds to step S207. In a case where the control unit 103 determines that the battery information is received from the battery pack 200 (YES in step S206), the control unit 103 proceeds to step S209.

In step S207, the control unit 103 determines whether the time during which the control unit 103 operates in the BMU power supply mode exceeds a predetermined time. In a case where the control unit 103 determines that the time during which the control unit 103 operates in the BMU power supply mode exceeds the predetermined time (YES in step S207), the control unit 103 proceeds to step S208. In a case where the control unit 103 determines that the time during which the control unit 103 operates in the BMU power supply mode does not exceed the predetermined time (NO in step S207), the control unit 103 returns to step S206.

In step S208, the control unit 103 ends the charging of the battery pack 200 as a charging error of the battery pack 200.

In step S209, the control unit 103 determines whether the battery pack 200 is recoverable to an operable state based on the information received from the battery pack 200 in step S206. In a case where the control unit 103 determines that the battery pack 200 is recoverable to the operable state (YES in step S209), the control unit 103 proceeds to step S210. In a case where the control unit 103 determines that the battery pack 200 is not recoverable to the operable state (NO in step S209), the control unit 103 proceeds to step S208.

Whether the battery pack 200 is recoverable to the operable state can be determined based on the cell voltages of the battery cells 202 and 203 of the battery pack 200. For example, a lithium ion battery cell that is left in the over-discharged state and that is put into a deeply-charged state with a cell voltage of about 1.0 V or lower may be in a state of being unrecoverable by charging. Thus, the control unit 103 determines whether the battery pack 200 is in a state of being recoverable to the operable state by determining whether each cell voltage is lower than or equal to a predetermined value based on the information received from the battery pack 200.

In step S210, the control unit 103 transmits a confirmation signal indicating that the battery information from the battery pack 200 is confirmed to the battery pack 200.

In step S211, the control unit 103 changes the BMU power supply mode to the normal charging mode and charges the battery pack 200 in the normal charging mode.

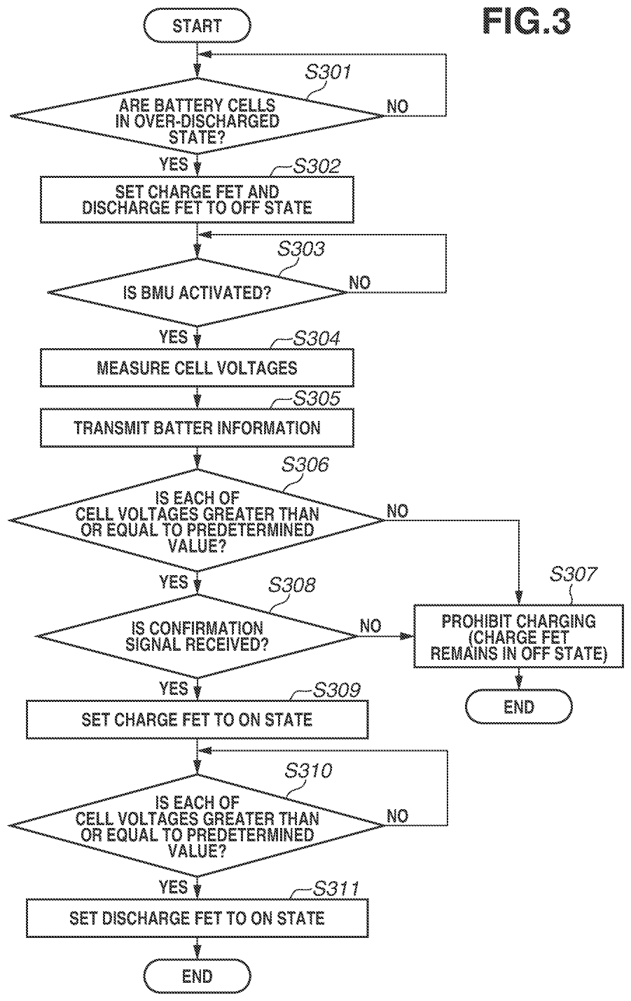

Next, an example of a process of the battery pack 200 according to the first exemplary embodiment will be described below with reference to FIG. 3. The process illustrated in FIG. 3 is controlled by the BMU 201 of the battery pack 200 by executing a program stored in a memory.

In step S301, the BMU 201 determines whether the battery cells 202 and 203 are in the over-discharged state. The BMU 201 detects each voltage of the two battery cells 202 and 203 connected in series. For example, in a case where a discharge termination voltage for the battery cells 202 and 203 is 2.5 V per cell, a voltage of about 2.3 V lower than 2.5 V can be used as a voltage for determining whether the battery cells 202 and 203 are in the over-discharged state. In a case where the BMU 201 determines that the battery cell 202 or 203 is in the over-discharged state (YES in step S301), the BMU 201 proceeds to step S302. In a case where the BMU 201 determines that the battery cells 202 and 203 are not in the over-discharged state (No in step S301), the BMU 201 returns to step S301.

In step S302, the BMU 201 puts the discharge FET 204 and the charge FET 205 into the off state. For example, in a case where the electronic device 100 and the battery pack 200 are unremovable from each other and integrated together, power is supplied to the BMU 201 separately from battery output to activate the BMU 201 so that the BMU 201 can communicate with the electronic device 100 even in a case where the discharge FET 204 and the charge FET 205 are both in the off state. However, in a case where the electronic device 100 and the battery pack 200 are removable from each other, the power supply line of the BMU 201 and the output line of the battery pack are generally configured to be the same line because an increase in number of connection terminals complicates the structure and the configuration enables the battery pack 200 alone to operate the BMU 201.

In the example illustrated in FIG. 1, a power supply Vcc terminal of the BMU 201 is connected to the node between the discharge FET 204 and the charge FET 205. In a state where the discharge FET 204 is in the off state and the charge FET 205 is in the on state, the voltages of the battery cells 202 and 203 are supplied to the power supply Vcc of the BMU 201 through the charge FET 205. Thus, activation of the BMU 201 depends on the voltages of the battery cells 202 and 203. For example, in a case where each of the voltages of the battery cells 202 and 203 is 0 V, the BMU 201 cannot be activated.

According to the first exemplary embodiment, power supplied from the electronic device 100 to the battery pack 200 is supplied to the power supply Vcc of the BMU 201 through the parasitic diode of the discharge FET 204 in order to put both the charge FET 205 and the discharge FET 204 into the off state. This enables activation of the BMU 201 using power supplied from the electronic device 100 regardless of the voltages of the battery cells 202 and 203. According to the first exemplary embodiment, the electronic device 100 supplies power to the battery pack 200 in the BMU power supply mode to activate the BMU 201. The battery pack 200 receives the power from the battery output line, and the power is supplied to the power supply Vcc of the BMU 201 through the parasitic diode of the discharge FET 204 to activate the BMU 201.

In step S303, whether the BMU 201 is activated is determined. In a case where it is determined that the BMU 201 is activated (YES in step S303), the BMU 201 proceeds to step S304. In a case where it is determined that the BMU 201 is not activated (NO in step S303), the BMU 201 returns to step S303.

In step S304, the BMU 201 measures the cell voltages of the battery cells 202 and 203.

In step S305, the BMU 201 transmits the battery information to the electronic device 100. The battery information contains the voltages, the charging current, and the discharge current of the battery cells 202, the voltage, the charging current, the discharge current, the temperature, and the battery level of the battery pack 200, and information (identification (ID) information, usage history, error information) about the battery pack 200. The battery information is generated based on, for example, measured cell voltages. In a case where whether the battery cells 202 and 203 are recoverable from the over-discharged state is determined based on a threshold value of the voltages of the battery cells 202 and 203, the battery pack 200 can determine the recoverability and transmit a result of the determination to the electronic device 100.

In step S306, the BMU 201 determines whether each of the cell voltages of the battery cells 202 and 203 is greater than or equal to a predetermined value. A lithium ion battery cell that is left in the over-discharged state and that is put into the deeply-charged state with a voltage of about 1.0 V or lower may be in a state of being unrecoverable by charging. Thus, the BMU 201 determines whether the battery cells 202 and 203 are in a state of being recoverable by charging or in a state where an attempt at recovery should not be made based on the cell voltages of the battery cells 202 and 203. In a case where the BMU 201 determines that the cell voltage of the battery cell 202 or 203 is not greater than or equal to the predetermined value (NO in step S306), the BMU 201 proceeds to step S307. In a case where the BMU 201 determines that each of the cell voltages of the battery cells 202 and 203 is greater than or equal to the predetermined value (YES in step S306), the BMU 201 proceeds to step S308.

In step S307, the BMU 201 puts the battery pack 200 into a charging-prohibited state and ends the process. At this time, the BMU 201 ends the process while the charge FET 205 remains in the off state.

In step S308, the BMU 201 waits for arrival of a signal from the electronic device 100, and determines whether a confirmation signal in response to the transmission of the battery information is received from the electronic device 100. In a case where the BMU 201 determines that a confirmation signal is not received from the electronic device 100 (NO in step S308), the BMU 201 proceeds to step S307. In a case where the BMU 201 determines that a confirmation signal is received from the electronic device 100 (YES in step S308), the BMU 201 proceeds to step S309.

In step S309, the BMU 201 puts the charge FET 205 into the on state. In this state, the electronic device 100 charges the battery pack 200 in the normal charging mode. Consequently, the battery cells 202 and 203 are recovered from the over-discharged state to a state where the battery cells 202 and 203 are chargeable. In a case where the voltages of the battery cells 202 and 203 are sufficient for recovery but not sufficient for activation of the BMU 201, putting the charge FET 205 into the on state causes the BMU 201 to be shut down, and the electronic device 100 can no longer communicate with the battery pack 200. Even in this case, the electronic device 100 charges the battery pack 200 in the normal charging mode to charge the battery cells 202 and 203 to a voltage sufficient for activation of the BMU 201.

In step S310, the BMU 201 determines whether each of the cell voltages of the battery cells 202 and 203 is greater than or equal to a predetermined value. In this step, whether the battery cells 202 and 203 recover from the over-discharged state and can discharge from an output terminal is determined. An example of a voltage to be determined is each of the cell voltages of the battery cells 202 and 203 that is about 3.0 V. In a case where the BMU 201 determines that each of the cell voltages of the battery cells 202 and 203 is greater than or equal to the predetermined value (YES in step S310), the BMU 201 proceeds to step S311. In a case where the BMU 201 determines that one of the cell voltages of the battery cells 202 and 203 is lower than the predetermined value (NO in step S310), the BMU 201 returns to step S310.

In step S311, the BMU 201 puts the discharge FET 204 into the on state. The battery cells 202 and 203 are charged to the fully-charged state with power supplied from the electronic device 100 to the battery pack 200 in this state.

As described above, according to the first exemplary embodiment, even in a case where the battery cells 202 and 203 of the battery pack 200 are in the over-discharged state, the BMU 201 of the battery pack 200 can be activated by power supplied from the electronic device 100. The activated BMU 201 measures the cell voltages of the battery cells 202 and 203, and based on the measured cell voltages, the BMU 201 determines whether the battery cells 202 and 203 are recoverable from the over-discharged state to the operable state, and controls the charge FET 205 properly. For this reason, even in a case where the battery cells 202 and 203 are in the over-discharged state, the charging of the battery pack 200 is controlled properly.

### Second Exemplary Embodiment

Various functions, processes, or methods described above in the first exemplary embodiment can be realized also by a personal computer, a micro-computer, a central processing unit (CPU), or a micro-processor by executing a program. In a second exemplary embodiment, the personal computer, the micro-computer, the CPU, or the micro-processor will be referred to as “computer X”. In the second exemplary embodiment, a program for controlling the computer X and realizing the various functions, processes, or methods described above in the first exemplary embodiment will be referred to as “program Y”.

The computer X executes the program Y to realize the various functions, processes, or methods described above in the first exemplary embodiment. In this case, the program Y is supplied to the computer X via a computer-readable storage medium. The computer-readable storage medium according to the second exemplary embodiment includes at least one of a hard disk device, a magnetic storage device, an optical storage device, a magneto-optical storage device, a memory card, a volatile memory, and a non-volatile memory. The computer-readable storage medium according to the second exemplary embodiment is a non-transitory storage medium.

While aspects of the disclosure are described with reference to exemplary embodiments, it is to be understood that the aspects of the disclosure are not limited to the exemplary embodiments. The scope of the following claims is to be accorded the broadest interpretation so as to encompass all such modifications and equivalent structures.

This application claims the benefit of Japanese Patent Application No. 2020-153787, filed Sep. 14, 2020, which is hereby incorporated by reference herein in its entirety.

What is claimed is:

1. An electronic device comprising:
a measurement unit that measures a voltage of a battery pack; and
a control unit that supplies power to the battery pack in a second mode different from a first mode in which the battery pack is charged, in a case where the voltage of the battery pack is lower than or equal to a predetermined value.

2. The electronic device according to claim 1, further comprising an acquisition unit that acquires battery information about the battery pack from the battery pack,
wherein the control unit changes the second mode to the first mode and supplies power to the battery pack in the first mode, in a case where power is supplied to the battery pack in the second mode and a voltage of a battery cell of the battery pack is greater than or equal to a predetermined value.

3. The electronic device according to claim 1, wherein the control unit does not determine whether the battery pack is in a fully-charged state, in a case where power is supplied to the battery pack in the second mode.

4. The electronic device according to claim 1, wherein the control unit determines that a charging error occurs in the battery pack in a case where a time during which power is supplied to the battery pack in the second mode exceeds a predetermined time.

5. The electronic device according to claim 2, wherein the battery information contains the voltage of the battery cell of the battery pack.

6. A battery pack comprising:
a battery cell;
a terminal to be connected to an electronic device;
a discharge switch and a charge switch that are put into an off state in a case where the battery cell enters an over-discharged state; and
a control unit that is activated with power supplied from the terminal through a parasitic diode of the discharge switch, measure a voltage of the battery cell, and transmit battery information generated based on the measured voltage to the electronic device in a case where the battery cell is in the over-discharged state.

7. The battery pack according to claim 6, wherein the control unit puts the charge switch into an on state after transmitting the battery information to the electronic device, in a case where the voltage of the battery cell is greater than or equal to a predetermined value.

8. A method comprising:
measuring a voltage of a battery pack; and
supplying power to the battery pack in a second mode different from a first mode in which the battery pack is charged in a case where the voltage of the battery pack is lower than or equal to a predetermined value.

9. The method according to claim 8, further comprising acquiring battery information about the battery pack from the battery pack,
wherein the second mode is changed to the first mode and power is supplied to the battery pack in the first mode, in a case where power is supplied to the battery pack in the second mode and a voltage of a battery cell of the battery pack is greater than or equal to a predetermined value.

10. A method comprising:
putting a discharge switch and a charge switch into an off state in a case where a battery cell of a battery pack enters an over-discharged state;
performing activation with power supplied from a terminal of the battery pack through a parasitic diode of the discharge switch of the battery pack and measuring a voltage of the battery cell in a case where the battery cell is in the over-discharged state; and
transmitting battery information generated based on the measured voltage to an electronic device.

11. A non-transitory storage medium that stores a program causing a computer to execute a method, the method comprising:
measuring a voltage of a battery pack; and
supplying power to the battery pack in a second mode different from a first mode in which the battery pack is charged in a case where the voltage of the battery pack is lower than or equal to a predetermined value.
